(19) United States
(12) Patent Application Publication
(10) Pub. No.: US 2018/0023734 A1
(43) Pub. Date: Jan. 25, 2018

(54) PIPE SLEEVE ADAPTER

(71) Applicant: Funke Kunststoffe GmbH, Hamm-Uentrop (DE)

(72) Inventors: Norbert Funke, Sendenhorst (DE); Hans-Günter Funke, Sendenhorst (DE)

(21) Appl. No.: 15/214,526

(22) Filed: Jul. 20, 2016

(51) Int. Cl. F16L 21/02

(52) U.S. Cl. CPC F16L 21/02

(57) ABSTRACT

A pipe sleeve adapter that is a universal replacement part that enables a thin-walled pipe to be connected to a pipe sleeve that was designed to receive thick-walled pipe. Pipe sleeve adapter and pipe sleeve have the same nominal dimension, but the outer diameter of the sleeve adapter is smaller than the inner diameter of the pipe sleeve. The sleeve adapter includes a pipe section and an elastically deformable seal that fits around the outer diameter of the pipe section. A stretch device is arranged beneath the seal and has an adjustable height dimension. Increasing the height of the stretch device exerts tension on the seal, which deforms elastically radially outward to an extent defined by the degree of change in height of the stretch device, thereby increasing the outer diameter of the seal to a dimension that corresponds to the inner diameter of the specific pipe sleeve.

### BACKGROUND INFORMATION

### Field of the Invention

The invention relates to the field of sleeve adapters for pipes.

### Discussion of the Prior Art

Pipes or conduits used in canalization and drainage systems typically have a thick wall, for example, a thickness of 30 or more millimeters, particularly if they are made of concrete or stoneware. Some conduits have structured walls, such as, for example, a plastic pipe with a smooth inner wall and an outer surface that is corrugated. The actual thickness of the wall, including the wall at the corrugated contour, is relatively thin, but due to the corrugated contour, the overall wall thickness dimension, i.e., the difference in size between the inner diameter and the outer diameter, corresponds to a relatively large wall thickness. By contrast, smooth-walled plastic conduit or pipe have walls that may vary in thickness, depending on the nominal diameter, but typically the walls of smooth-plastic conduit are thinner than those of older pipe, i.e., conduits made of concrete or stoneware.

It is often problematic to repair or improve pipe systems, or replace pipes of one material with pipes made of a different material, due to differences in wall thickness between the original pipe and the replacement pipe. The inner diameters of the various types of pipe sections correspond to the rated dimensions, but the outer diameters may vary widely, depending on the specific manufacturer and the material used. Consequently, when laying new pipe in an existing pipe system, it is often difficult to connect a new pipe section to the pipe sleeve of an already existing pipe system. This is often the case, when, for example, decades old shafts or pipes have to be repaired. The pipe manufacturer of the original conduit may have gone out of business; pipe sections having the same outer diameter are possibly no longer available; or the wall thickness of the new pipe is thinner than that of the old pipe. The pipe sleeve in an already existing shaft or pipe section may have a substantially larger inner diameter, because it is dimensioned to receive a pipe section with a thick wall. So, even though the old and the new pipes have the same nominal size rating, the thinner wall of the new pipe makes it difficult to connect to and achieve a seal with the already existing pipe sleeve.

What is needed, therefore, is a pipe sleeve adapter that enables thin-walled pipe to be connected to a pipe sleeve that is designed to receive thick-walled pipe. What is further needed is such an adapter that is adjustable, so as to accommodate differences in different pipes with the same nominal rating.

### BRIEF SUMMARY OF THE INVENTION

The object of the invention is to provide a pipe section that is a universal replacement part that makes it possible to connect a thin-walled pipe to a pipe sleeve designed to receive a thick-walled pipe. The sleeve adapter has a pipe section and a seal that encircles the outer circumference of the pipe section. The seal is made of an elastically deformable material, so it is deformable, i.e., is stretchable lengthwise and/or widthwise, and serves to adapt the sleeve adapter to pipe sleeves of different inner diameters. For example, the seal may be expanded radially outward, i.e., stretched, so that the sleeve adapter is able to form a proper fit to a particular pipe sleeve that has a larger inner diameter than the outer diameter of the pipe section on the adapter. At least one stretch device is arranged radially inside the seal, i.e., between the pipe section and the seal. The stretch device has an adjustable height dimension, so that, if the pipe section to be fitted to the pipe sleeve has a smaller outer diameter than the inner diameter of the pipe sleeve, the stretch device may be adjusted beneath the seal, so as to cause the seal to stretch radially outward and thereby achieve tight contact between the seal and the inside of the pipe sleeve. The stretch device, depending on its position on the pipe sleeve adapter, may be expanded in various ways, lengthwise or widthwise.

The seal is arranged at one end of the pipe section, whereby this end is the insertion end that serves as the connector to a thick-walled conduit or to a conduit with an inner diameter that is larger than the outer diameter of the pipe section on the adapter. The opposite end of the pipe section is constructed as a pipe sleeve or tapered end such, that it may be connected to the replacement pipe by means of a conventional sleeve connector.

The sleeve adapter according to the invention is also suitable to provide a seal against a surrounding wall at the point of entry of a pipe into a house or building. In this case, the seal is not placed at one end of the pipe section, but there, where the pipe section is surrounded by the wall of the building. One end of the pipe section is constructed as the sleeve end and the other end the tapered end. This use of the sleeve adapter according to the invention allows additional sections of conduit to be connected, both inside and outside the building.

In a first embodiment of the sleeve adapter according to the invention, the stretch device includes at least one wedge and at least one abutment that together serve to stretch the seal of the sleeve adapter. The wedge and the abutment are arranged inside the seal, i.e., between the pipe section and the seal, and are movable relative each other in the axial direction, so that the two elements can overlap each other, whereby the degree of overlap is adjustable. This ability to adjust the overlap of the wedge and abutment has the effect that the stretch device is able to adjust the stretch on the seal to varying degrees and, thus, to change the outer dimension of the seal. In this way, the outer dimension of the seal is adjustable, so that the outer diameter of the sleeve adapter that is inserted into the pre-existing pipe sleeve can form a proper seal against the inner surface of the pipe sleeve.

The abutment does not have to be movable, but instead, may be fixed in location on the pipe section and may, for example, be constructed as a closed ring. This simplifies the production, because it reduces the number of components that need to be handled. Nevertheless, it is possible to use a plurality of abutments. For example, an abutment may be provided for each wedge. Also, abutments having different dimensions may be provided.

The wedge is a movable component and the circumference of the seal is increased by moving the wedge so as to increase the degree of overlap of the wedge with the abutment. This requires that the wedge either be suitably stretchable or that multiple wedges be distributed over the circumference of the pipe section, whereby the distance between the wedges increases as they are progressively moved. A plurality of individual wedges may be used, so that it is possible to produce sleeve adapters with different nominal diameters by adapting the number of wedges to achieve the desired outer diameter of the sea.

In practice, pipe sleeves frequently have a shallow insertion depth, typically only up to 80 mm. In order to be able to use the sleeve adapter according to the invention as a universal spare part, i.e., to be able to adapt the sleeve adapter to many different inner diameters of different pipe sleeves, it is advantageous if the necessary travel path of the wedge to attain the desired outer diameter of the seal is as short as possible. It is also advantageous, if conventional, commercially available wedges may be used. An example of such a suitable component is the so-called roofing wedge or rafter wedge, a component that is typically used to fill out the space between a rafter and a lath in a roof construction in which laths are placed across roof rafters. These wedges are inexpensive and readily available, and also available in various material thicknesses. They have a relatively short and relatively steep insertion slope and, because of that, when used in the pipe sleeve adapter according to the invention, require a relatively short adjustment distance in order to achieve a relatively large stretch of the seal and, thus, a relatively large increase in the outer circumference of the sleeve adapter at the area of the seal.

A plurality of circumferential protrusions may be formed on the seal. For example, the wall thickness may remain consistent and the protrusions be in the form of corrugated or bead-like contours, or the wall thickness may vary and the protrusions be formed as ribs that extend radially around the seal. Such protrusions improve the effectiveness of the seal against the inner surface of the sleeve that receives the sleeve adapter. Furthermore, these protrusions may be constructed as barb-like hooks and in this way prevent the seal from shifting its position on the pipe section.

A drive ring may be used to move the wedge relative the abutment. The drive ring is used to push against one or the plurality of wedges, so that moving the drive ring in the axial direction on the pipe section pushes the wedges onto the abutment. This increases the distance of the upper edge of the wedge from the pipe section, thereby forcing the seal to stretch radially outward. Alternatively, the wedges may be movable in the radial direction, but unmovable in the axial direction on the pipe section. In this case, the abutment is pushed in the axial direction along the pipe section, thereby shifting the wedges radially outward and stretching the seal. In this case, the drive ring makes contact with the abutment or possibly forms the abutment.

The drive ring may be constructed as a stop ring with a stop surface. A plastic or rubber hammer may be used, for example, to hit against the stop surface to push the drive ring in the axial direction along the pipe section. Instead of driving the drive ring with the help of hammer blows, the drive ring may be shifted along the pipe section with the help of one or more pressure elements. In this case, a clamp ring is used to move the drive ring. This clamp ring may be fixed in place on the pipe section and have at least one pressure element that extends from the clamp ring to the drive ring. The pressure element may, for example, be a pneumatic or hydraulic pillow that expands under pressure. On the other hand, a plurality of pressure elements, for example, spindles, may be distributed along the circumference of the pipe section, between the clamp ring and the drive ring, whereby the distance between the clamp ring and the drive ring is changed, depending on the direction in which the spindles are actuated. Actuating the one or more pressure elements increases the distance between the clamp ring and the drive ring in the axial direction on the pipe section, with the result that the degree of overlap of the wedge and the abutment is increased, thereby stretching the seal. For example, a relatively small force may be sufficient to actuate multiple spindles and achieve a smooth shifting of the drive ring, without the risk of canting or edging over the ring.

Lock elements, such as, for example, a lock claw, may be provided, to prevent a backward shift of the stretch device after the configuration for the desired stretch has been set. The lock claw is provided on one of the movable elements that contribute to increasing the degree of overlap between the wedge and the abutment, for example, on the drive ring, on the wedge, or on the abutment. The stop claw is provided on the radial inner side of the particular movable element, so that it makes contact with the outer surface of the pipe section. The claws have a slanted orientation to the outer surface of the pipe section, and because of this, tend to dig into the pipe section when a backward force is exerted on the lock claw and, indeed, the tendency to dig into the pipe section increases as the backward force exerted on the lock claw increases. This effectively prevents a backward movement of the stretch device, so that the stretch on the seal is maintained.

The stop claw may be made of metal or plastic. It has been found in initial tests that the claw may be stamped or cut from flat sheet metal. A plurality of lock claws may be distributed on the abutment around the circumference of the pipe section. The plurality of stop claws may also be manufactured as a single component, namely, as a metal ring that extends around the pipe section.

The undesired backward movement may also be prevented by angled or slanted teeth that are formed between the wedge and the abutment, whereby the slanted orientation of the teeth allows a forward movement of these two elements that increases the degree of overlap, but prevents a backward movement.

Advantageously markings may be provided on outer surface of the pipe section, in the axial direction. These markings serve as a guide in attaining the desired effect, and particularly, the desired diameter of the sleeve adapter in the area of the seal, either during manual assembly or in a machine-supported automatic assembly: If the markings extend in the circumferential direction around the pipe section, the slanted positions of the abutment or the wedges or the drive ring to the axis of the pipe section can be readily determined, either with optical sensors of an automatic forward push unit that is used to assemble the sleeve adapter, or by means of a visual inspection by personnel. If, for example, the drive ring is constructed as a stop ring, inspection or optical control will be able to ascertain, that the distribution of the abutments is done in a way that the drive ring is always optimally oriented transverse to the axis of the pipe section. Inspection of the orientation of the drive ring ensures that the seal is stretched or pressed evenly across the entire circumference, thereby ensuring an optimal, even, tight seating of the seal inside the sleeve that receives the sleeve adapter.

Unbroken lines may be used as the markings. Compared to markings that consist of multiple single sections, for example, dashed lines, dots, etc., unbroken lines enable particularly reliable optical detection that shows whether a movable component such as, for example, the aforementioned drive ring, is set at an even distance to the line all around the circumference of the pipe section. This is true both for an automatic optical detection as well as for a visual inspection by a person during the assembly of the sleeve adapter.

The markings are provided one behind the other in the axial direction, and because of this, they may be different, in order to clearly indicate, to which dimension the seal is stretched when the stretch device is set to a particular marking, i.e., which outer circumference or outer diameter the sleeve adapter has in the area of the seal. Advantageously, the markings may be visually different, for example, have different colors, or be identified with readable text, for example, directly indicate the millimeter information of the outer diameter of the seal at the particular marking.

When preparing the sleeve adapter for insertion into a pipe sleeve, the inner diameter of the pipe sleeve may be determined first, then the sleeve adapter prepared prior to insertion by stretching the seal on the sleeve adapter so far, that it has an outside diameter that corresponds to the inner diameter of the sleeve. In this way, it is possible to insert the sleeve adapter easily into the sleeve, without having to apply force. The seal is then adjusted subsequent to insertion, however, but only a relatively small movement of the wedge relative the abutment is then needed, to stretch or widen the seal so as to achieve a tight, positive form-fit contact with the sleeve. Depending on the situation that presents itself at the installation site, for example, when reconstructing or replacing a sewer pipe line that is buried underground, access to the drive ring may be difficult or limited, so that it is often advantageous if a large portion of adjustment path of the wedge and thus a large portion of the needed stretch on the seal is done in advance in a comfortable setting, rather than at the installation site.

In a second embodiment of the sleeve adapter, the stretch device is constructed as a knee lifter. The middle section of the knee lifter, which is jointed or articulated, is mounted near to or even directly on the pipe section. The mount for the knee lifter may have a recess that is provided on the outside of the pipe section, to hold/guide the knee lifter. For example, the recess can be a groove or a protrusion, for example, a ring, that extends around the outside circumference of the pipe section, or can be in the form of a plurality of separate elements, such as screws, pins, or similar elements. A first lifter extends from the middle section of the knee lifter radially outward, away from the pipe section, and a second lifter on the opposite end of the knee lifter is in contact with the second, movable section of the seal that is outwardly stretchable. When the first lifter is guided toward the pipe section, the second lifter moves outwardly farther away from the pipe section, in the radial direction, thereby stretching the seal, so that the seal has a larger outer diameter.

It can be advantageous with such a sleeve adapter that the seal extend with an essentially U-shaped cross-section under the middle section of the knee lifter. With this essentially U-shaped cross-section, the seal thus surrounds the second lifter of the knee lifter. The seal is thus pressed on the one hand radially outward, namely, there where the second lifter presses against the inside surface of the seal, and, on the other hand, it is pressed radially inward against the pipe section, namely there where it extends between the middle section of the knee lifter and the pipe section.

The knee lifters of the sleeve adapter may also be secured on the pipe section against axial shifting and for this reason may be mounted in a fixed location. To this end, a ring may be provided on the pipe section and the middle section of the knee lifters grab around this ring, at least partially.

In an advantageous further embodiment of such a sleeve adapter, the ring is constructed eccentrically, so that, on the one hand, the pipe section is eccentrically placed in the sleeve end of an adjacent pipe, so that the connection of the sleeve adapter with the adjacent pipe is even with the sole of the pipe in the lower portion of the pipe section. The middle sections of the knee lifters that are distributed around the circumference of the pipe section are different distances from the central axis of the pipe section, due to the eccentric ring, and, indeed, advantageously in the way that they are essentially distributed concentrically around the central axis of the adjacent pipe, approximately the same tension may be applied to all of the knee lifters. This ensures an even contact pressure of the seal over its entire circumference at the sleeve end of the adjacent pipe. Different eccentric rings may be provided, depending on the geometric embodiments of the mentioned adjacent pipe, i.e., the rings may differ in their outer diameters and/or inner diameters and/or with regard to their eccentricity.

Using an eccentric ring is also advantageous for providing an apex marking at the highest point of the circumference: this makes it possible to check visually from the outside whether the sleeve adapter is correctly assembled in the and positioned.

The contact between the second lifter and the second section of the seal may be done by means of a pressure plate. The advantage of the pressure plate is that it provides a large surface area where stretch force is exerted on the seal. This effectively distributes the stretch force evenly on the seal, thereby reducing mechanical stresses and loads on the seal material.

An articulated or jointed mount may be used to couple the pressure plate to the second lifter, so that the orientation of the pressure plate is able to optimally adapt to the stretched second section of the seal. This also minimizes the friction forces between this second section of the seal and the pressure plate, which could otherwise hinder the ability of the seal to stretch.

The middle section of the lifter, there where the lifter is tiltably mounted, may be significantly narrower than the pressure plate. The surface of the pipe section against which the lifter possibly makes contact is curved. This ensures that the mounting for the knee lifter is smooth or even in all tilt positions of the lifter. Alternatively, the middle section of the lifter, there, where it is tiltably mounted, may intentionally be designed to be wide, in order to avoid a point pressure load on the pipe section. This is advantageous, because of the comparatively thin wall thickness of the pipe section. In this case, the contact surface where the lifter makes contact with the pipe section may be curved in two directions, similar to a cylinder, that is however narrowed along its longitudinal axis: on the one hand, the contact surface runs parallel to the tilt axis, following the circumference of the pipe section, so that the largest possible surface area for supporting the lifter is provided on the pipe section. On the other hand, the surface has a convex curve transverse to the tilt axis, so that the desired contact with the pipe section is ensured in all tilt positions.

Aside from reducing the pressure load that is exerted on the pipe section, the wide construction of the lifter has a positive effect on securing the knee lifter against shifting: for example, the lifter may be fixed in location on the pipe section by means of a retainer or tension band. In order for the lifter to continue to be able to tilt, this retainer or tension band is preferably placed in the middle section of the knee lifter, and as close to the top of the tilt axis as possible. The wide construction of the lifter in this area reduces the surface pressure that acts on the retainer or tension band, so that high retaining or tension forces can be exerted on the band, without exerting undue stresses on the material.

The tensioning movement of the first lifter may advantageously be achieved by means of a flexible tension element that extends around all knee lifters, for example, a tension clamp or a tension cable. Corresponding guide surfaces may be provided on the first lifters of the knee lifters, in order to prevent the flexible tension element from slipping off one of the first lifters during the tensioning process or even later, so that the guide surfaces ensure that each of the knee lifters maintains its desired tensioning position.

The pipe section of the sleeve adapter is cylindrically constructed in the area where the pipe section is inserted into the sleeve of the existing pipe conduit, as was mentioned at the beginning. The opposite end of the pipe section may be constructed as a tapered end, so that the pipe section is overall constructed cylindrically and serves as an intermediate piece or adapter piece to connect two sleeves, namely, on the one side with a sleeve having a relatively thick wall, for example, made of concrete, and on the other side with a plastic sleeve having a relatively thin wall. The opposite end of the pipe section may, however, also be selectively constructed as a sleeve end, so that the alignment of the individual pipes in the pipe system does not have to be changed. In other words, the sleeve adapter according to the invention makes it possible to just change the material, for example, from concrete or ceramic to plastic pipe, without having to realign the pipes.

Advantageously, after the seal has been stretched, a tension-relief device may be placed under the free ends of the knee lifters, i.e., the lifters that do not make contact with the seal, in order to reduce the mechanical loading of the knee lifters that are provided on the upper circumferential section of the sleeve adapter. Suitable materials for this relief device include a putty-like material or grouting compound that cures to a hardened state, or solid components, such as spacers, wedges, etc. The tension-relief devices serve to deflect loading from above that would be exerted on the sleeve adapter and possibly damage or deform the knee lifters. This may be a concern, if, for example, the sleeve adapter is in a ditch that will subsequently be filled in, because the weight of the fill material—or from the impact energy—when the ditch is filled, or subsequent compaction of the fill material, such as occurs, for example, when there is vehicle traffic above the ditch, can possibly result in damage.

### BRIEF DESCRIPTION OF THE DRAWINGS

The present invention is described with reference to the accompanying drawings, which are purely schematic. In the drawings, like reference numbers indicate identical or functionally similar elements.

FIG. 1 is a perspective view of a pipe sleeve adapter, showing a longitudinal cross-section.

FIG. 2 is a cross-section of the wall of the pipe sleeve adapter of FIG. 1, showing the seal and adjacent components.

FIG. 3 is a cross-section of a second embodiment of the pipe sleeve adapter.

FIG. 4 is a cross-section of a third embodiment of the pipe sleeve adapter.

FIG. 5 is a cross-section of a fourth embodiment of the pipe sleeve adapter.

FIG. 6 is a cross-section of a variation of the fourth embodiment.

FIG. 7 is a cross-section of the sleeve adapter according to the invention assembled in a pipe sleeve, showing an eccentric placement of the sleeve adapter.

### DETAILED DESCRIPTION OF THE INVENTION

The present invention will now be described more fully in detail with reference to the accompanying drawings, in which the preferred embodiments of the invention are shown. This invention should not, however, be construed as limited to the embodiments set forth herein; rather, they are provided so that this disclosure will be complete and will fully convey the scope of the invention to those skilled in the art.

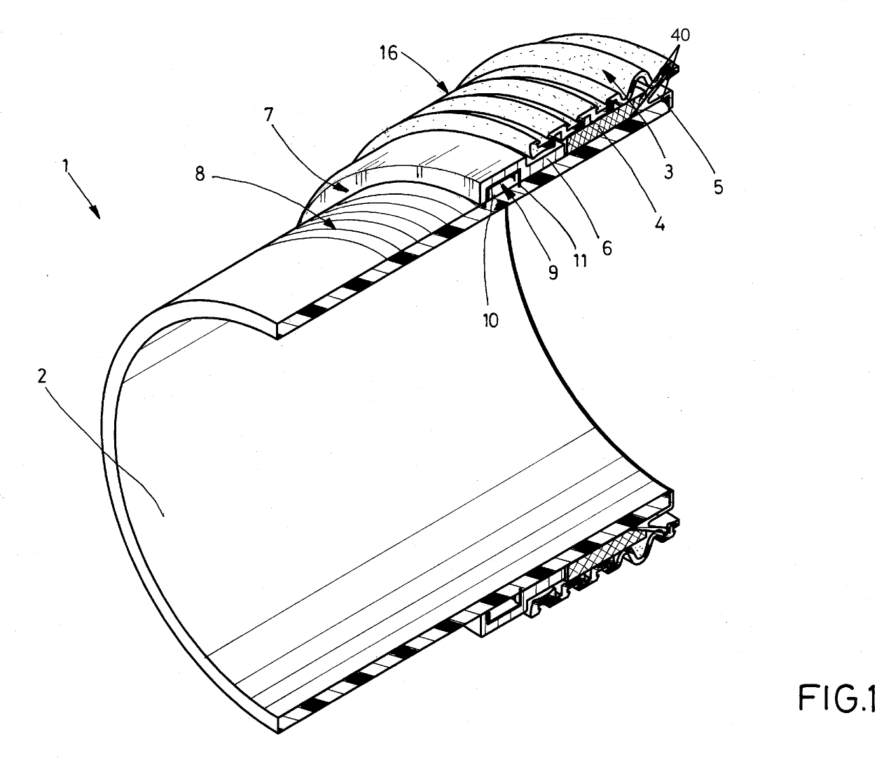

FIG. 1 illustrates a pipe sleeve adapter 1 according to the invention, comprising a pipe section 2, a seal 3 that extends circumferentially around the pipe section 2, and a stretch device 40 arranged between the pipe section 2 and the seal 3. In this embodiment, the stretch device 40 includes a plurality of first wedges 4 and a corresponding plurality of abutments 5, which, in this embodiment, are also referred to as second wedges 5. Each of the first wedges 4 has one end with a slanted surface that butts up against the slanted surface of a corresponding second wedge 5 and against second end that butts against a circular ring 6. The circular ring 6 is embodied as a drive ring and has a corresponding contact surface 7.

Markings 8 are provided around the pipe section 2. In the embodiment shown, the markings 8 are parallel rings, one behind the other in the axial direction. It is understood that these markings 8 may be provided in different forms. For example, the markings 8 can be numbers which indicate the particular outer diameter of the seal 3, depending on the position of the first wedges 4. Even if such numbers are not used, the markings 8 enable a visual inspection or optical control that is able to determine whether the drive ring 6 is precisely aligned or has inadvertently been canted or misaligned on the pipe section 2.

The drive ring 6 has a hollow contour 9 that is close to the contact surface 7. A metal ring 10 having a plurality of grip claws 11 is fitted into this contour 9. The grip claws 11 are shown in the figures in their non-deformed state, so that it appears that these claws 11 extend precisely in the radial direction into the material of the pipe section 2. In fact, however, the grip claws 11 extend at an angle into the hollow space 9 and make contact against the outer surface of the pipe section 2. Due to the angled orientation of the claws 11, they act as barbs and allow the drive ring 6 to be pushed in the direction toward the second wedge 5, but prevent a movement of the drive ring 6 in the opposite direction, because the grip claws 11 dig into the material of the pipe section 2 when movement in the opposite direction begins. This effectively reinforces the stop action of the grip claws 11 under increasing loading.

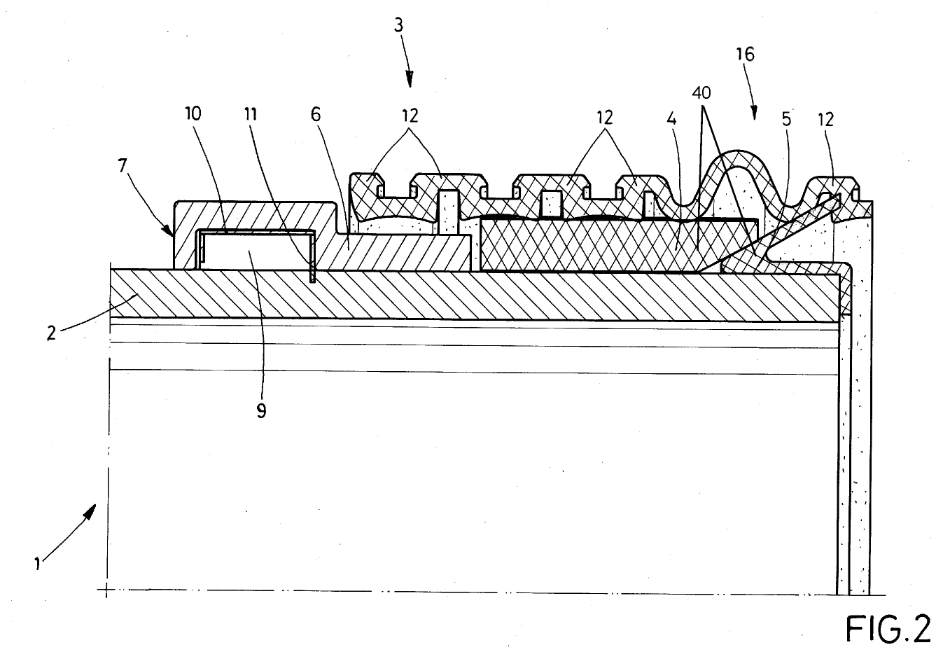

FIG. 2 illustrates the seal 3 in greater detail. The seal 3 is made of an elastomeric material and has a plurality of raised contours or protrusions 12 that extend circumferentially around the pipe section 2. On the one hand, these protrusions 12 improve the sealing effect of the seal 3 when it makes contact against the inside of a pipe sleeve; on the other hand, they improve the stretchability of the seal 3 when it is stretched in the radial direction. The seal 3 lies with a positive form fit against the drive ring 6. The drive ring 6 forces the first wedge 4 onto the second wedge 5, increasing the distance between the slanted edge of the wedge 4 and the surface of the pipe section 2. The section of the seal 3 that encircles the stop ring 6 and the wedge 4 is then pushed or jammed together with the two components. Hence, no frictional resistance need be overcome between the two components and the seal ring 3.

The second wedge 5 is constructed as a ring and, in the embodiment shown in FIGS. 1 and 2, a plurality of first wedges 4 are pushed onto the stationary, i.e., immovable, second wedge 5. The seal 3 is thereby stretched in the radial direction at the end that is relatively far from the stop surface 7 of the drive ring 6 and close to the end of the pipe sleeve adapter 1 that is to be fitted into a pipe sleeve.

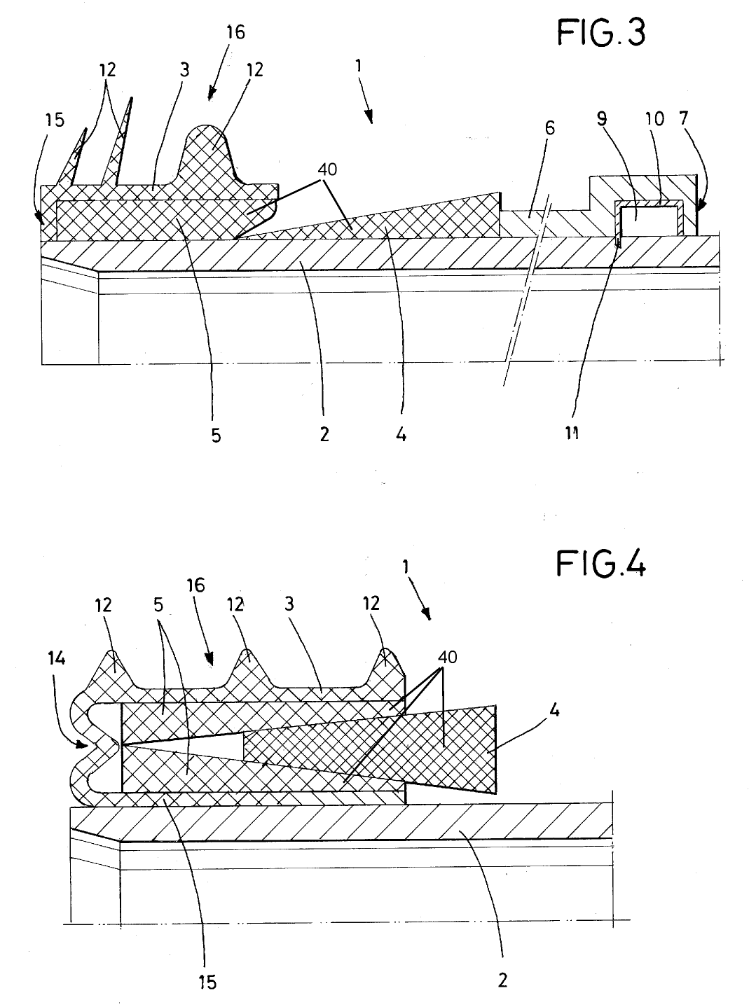

FIG. 3 illustrates an alternative embodiment of the stretch device 40 in which two elements with slanted wedge surfaces are fitted radially between the seal 3 and the pipe section 2. The first of these two wedge elements is fitted directly adjacent the seal 3 and is referred to as a second wedge 5. A plurality of such second wedges 5 are provided on the pipe section 2, where they remain stationary in the axial direction on the pipe section 2. The second of the two wedge elements is an annular shaped, single-piece first wedge 4 that is provided as a stretch element that is wedged by the contact ring 6 and its contact surface 7 between the plurality of second wedges 5 and the surface of the pipe section 2. This forces the wedge end of the second wedges 5 radially outward, thereby increasing the distance between the slanted end of the second wedges 5 and the pipe section 2, thereby stretching the seal 3 to a greater diameter, the greatest increase being at the end of the seal 3 that is farthest from the insertion end of the pipe sleeve adapter 1

FIG. 3 also illustrates that a first section 15 of the seal 3 at the end that is farthest from the first wedge 4 extends down behind the second wedge 5 and makes direct contact with the pipe section 2. This first section 15 of the seal 3 may be affixed to the pipe section 2, for example, adhesively affixed. This creates a fluid-tight transition from the inside of the pipe section 2 to the inside of the pipe sleeve, when the seal 3 is stretched wide enough to make tight contact with the pipe sleeve. A second section 16 extends from the first section 15 of the seal 3 in a direction away from the insertion end of the pipe section 2. The first wedge 4 and the second wedges 5 force this second section 16 to stretch in the radial direction.

Similarly, in the embodiment illustrated in FIG. 1, the seal has a first section 15, which is not shown for reasons of clarity. This first section 15 makes contact with the pipe section 2 in a fluid-tight manner, and the first wedge 4 and the second wedges 5 force the second section 16 of the seal 3 to stretch in the radial direction.

FIG. 4 illustrates an embodiment of the stretch device 40 includes two second wedges 5 and a first wedge 4 arranged therebetween. The second wedge 5 closer to the pipe section 2 is designated the inner second wedge and the wedge 5 closer to the contour surface of the seal 3 is designated the outer second wedge. The wedge 4 may be constructed as a single-component ring and the radial inner second wedge 5 also. Preferably, however, the outer second wedges are provided as a plurality of separate second wedges 5. This configuration allows the seal 3 to be stretched radially simply by increasing the distances between the individual outer second wedges 5, so that the outer diameter of the seal 3 is increased until it fits tightly against a pipe sleeve. In this embodiment, the seal 3 has a stretch groove 14 at the insertion end of the sleeve adapter 1. This groove 14 connects the first section 15, which is tight up against the pipe section 2, with the second section 16 of the seal 3. Similar stretch grooves may also be provided between the sections 15 and 16 of the respective seals 3 in the embodiments shown in FIGS. 1-3.

In the embodiments shown in FIG. 1-4, the surfaces of the first wedge 4 and the upper and lower second wedges 5 that make contact with each other may have a saw-tooth profile, so that the first wedge 4 may be moved in between the two second wedges 5 in a forward movement, but a backward movement is prevented.

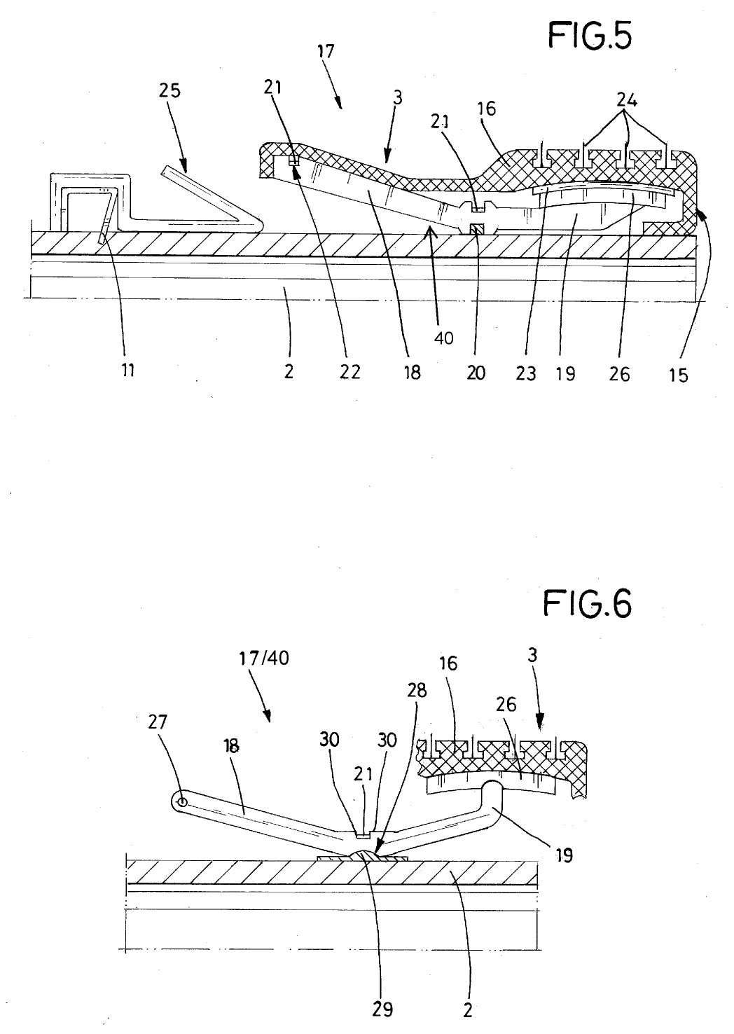

FIG. 5 illustrates an embodiment in which the stretch device 40 includes a plurality of knee lifters 17, rather than the wedges 4, 5. A ring 20 serves to fix the position of the knee lifters 17, so that they cannot be pushed in the axial direction on the pipe section 2. The ring 20 may be made of metal or plastic. The stretch device or knee lifter 17 has a first lifter 18, the free end of which initially, when the knee lifter 17 is in it resting position, is some distance away from the pipe section 2. The knee lifter 17 has a second lifter 19, which, in the resting position of the stretch element shown in the figure extends close to the pipe section 2. This second lifter 19 extends rearward, away from the insertion end and under the second section 16 of the seal 3 that is outwardly movable.

The knee lifter 17 shown in FIG. 5 is moved from the resting position to a tensioning position by pressing the first lifter 18 toward the pipe section 2. This is done in the embodiment shown by means of a tensioning clamp 21. A groove 22 for the clamp 21 is provided in the first lifter 18. Just by way of example, a similar tension clamp 21 is provided in the central area, between the two lifters 18 and 19 of the knee lifter 17. This second clamp 21 and the groove 22 serve, in conjunction with the ring 20, to fix the knee lifter 17 in a stationary position on the pipe section 2. This second tensioning clamp 21 may possibly be eliminated if, for example, the seal 3 itself is constructed in a way that prevents the knee lifter 17 from shifting undesirably. This is achievable, for example, by a corresponding geometry of the knee lifter 17 and the seal 3, whereby the seal 3 is adapted to have a positive form fit on sections of the knee lifter 17.

A slide pad 23 enhances the actuation of the knee lifter 17 when tension is applied and enables relative movement between the second lifter 19 of the knee lifter 17 and the second section 16 of the seal 3. Claws 24 are provided on the second section 16 and extend radially outward beyond this second section 16. They may be constructed similarly to the grip claws 11, for example, as sections of a metallic ring that extend outwardly, but that are flatter and, thus, constructed differently than the metal ring 10 shown in FIGS. 1-3.

A fixing wedge 25 serves in this embodiment not as a stretch element, but rather, to fix the knee lifter 17 after it is tensioned. The fixing wedge 25 is pushed in the axial direction onto the pipe section 2 and secured against inadvertent back movement by a stop tongue 11.

If looked at in a top plan view, the knee lifter 17, depending on the wall thickness or the pressure resistance of the pipe section 2, may be constructed in various ways. For example, in a first embodiment, the lifter 17 may have an hour-glass, almost X-shaped contour, namely be a wide pressure plate 26 against which the second lifter 19 makes contact, so that the seal 3 is stretched outwardly over a large area. And the first lifter 18, too, may be wider toward its free end, particularly in the area of the clamp groove 22, so that the load exerted by the tension clamp 21 is distributed over a large area of the tension clamp 21, enhancing its holding force. On the other hand, in the central area where the knee lifter 17 is tiltably mounted in the area of the ring 20, the lifter 18 may be relatively narrow, so that, in various tilted positions, the lifter 18 always makes good contact with the curved outer surface of the pipe section 2. In a second embodiment, the lifter 18 may also be relatively wide in the central area, so that the least possible surface pressures are sufficient, in order to protect the pipe section 2 as well as the tensioning clamp 21 from mechanical overloads.

In a fourth embodiment shown in FIG. 5, the pressure plate 26 is fixedly bonded with the second lifter 19. Alternatively to the embodiment shown in the figure, it is possible that the pressure plate 26 also serve as the second lifter 19. In contrast to that, in the embodiment shown in FIG. 6, the pressure plate 26 is hingedly mounted on the second lifter 19, thereby minimizing relative movements between the pressure plate 26 and the second section 16 of the seal 3 so that, as a result, for example, a slide pad 23 is not required.

A variation of the fourth embodiment is shown in FIG. 6. This embodiment differs from the one shown in FIG. 5 in that there is no tension groove 22 on the first lifter 18, but rather, an eye 27 through which a tensioning cable may be threaded.

A bearing recess 28 is provided in the middle of the knee lifter 17, between the two lifters 18 and 19, that serves to tiltably mount the knee lifter 17. A tilt bead 29 provided on the pipe section 2 interacts with the recess 29 to allow a tilting motion of the two lifters 18 and 19. The tilt bead 29 is constructed as a plastic or a metal band that encircles the circumference of the pipe section 2 and may be fixed in location, for example, adhesively. The knee lifter 17 slides with its bearing recess 28 on the tilt bead 29 during a tilt movement and is also fixed in its location in the axial direction of the pipe section 2 by means of a tension clamp 21 that presses the knee lifter 17 against the tilt bead 29. Two lateral guides 30 ensure that the tension clamp 21 seats reliably against the knee lifter 17.

The inner side of the band that forms the tilt bead 29 and extends radially around the pipe section 2 may be perfectly round, adapted to conform to the geometry of the pipe section 2, whereas, the outer side may be polygonal, so that is may be referred to as a polygonal bearing ring. Ideally, the number of the outer corners or the straight sections that extend between the corners corresponds to the number knee lifters 17 that are provided, such that a tilt bead 29 is provided under each lifter 17. The tilt bead 29 extends in a straight line around the circumference of the pipe section 2, thereby providing the widest possible tilt bearing for the respective knee lifter 17. Accordingly, the knee lifter 17 may also be constructed to be relatively wide in its middle area between the lifters 18 and 19. This wide bearing surface distributes the pressure forces that the knee lifter 17 exerts on the pipe section 2, so that the surface pressure applied is reduced, thereby avoiding excessive loading on the pipe section 2. From another point of view, applying the highest admissible loading on the pipe section 2 means that optimally high tension forces are applied to the knee lifter 17, thereby optimizing the seal effect of the seal 3 on the sleeve adapter 1 against the inner surface of the respective pipe sleeve.

With a centrally seated pipe sleeve adapter 1 having knee lifters 17 as the stretch device 40, tension is simultaneously applied to the first lifters 18 of all knee lifters 17. The aforementioned tensioning clamp 21 or tensioning cable is used to apply tension to the lifters 18. Even if the stretch devices 40 are constructed as first wedges 4 and second wedges 5, the same amount of tension may be exerted on all of these elements simultaneously, for example, by moving all wedges 4 by means of the contact ring 6 the same distance relative each respective second wedge 5.

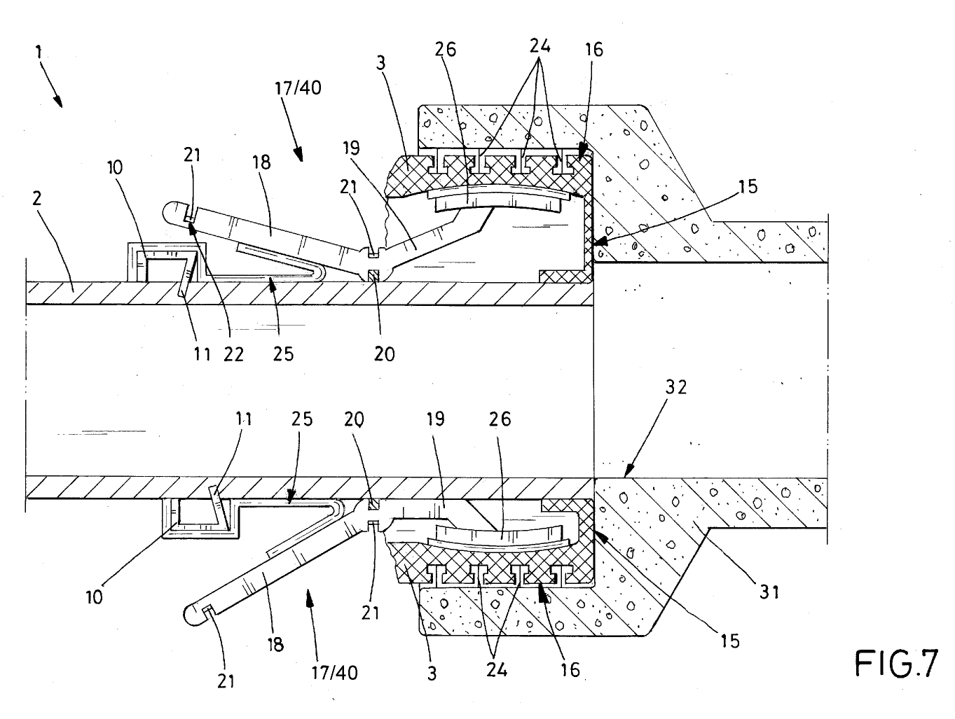

FIG. 7 illustrates, however, that it may be advantageous to place the pipe sleeve adapter 1 eccentrically in the respective pipe sleeve 31, and to apply different amounts of tension to the individual stretch elements. As shown in FIG. 7, the pipe sleeve 31 has a thick wall, such as is typical for a concrete pipe, whereas the pipe section 2 of the pipe sleeve adapter 1 is made of plastic and has a thin wall. It is desirable, that, in the lower portion of the pipes, where liquid will be flowing, the transition from the pipe section 2 to the pipe sleeve 31 is as smooth as possible. In order to achieve an unstepped, smooth transition in a configuration in which the inner diameter of the sleeve adapter 1 is smaller than that of the pipe sleeve 31 to the sleeve adapter 1, the sleeve adapter 1 is assembled in the sleeve 31 with a vertical offset, in other words, it is not centered in the pipe section, but rather, placed such that the transition in the deepest area of the sleeve 31, namely, in the area of the so-called pipe sole 32, is smooth. In this case, different amounts of tension are applied to the stretch elements 40 along the circumference of the pipe section 2.

As shown in FIG. 7, the knee lifters 17 on the upper portion of the pipe section 2 are tipped much more in the radial direction when tensioned than the knee lifters 17 in the lower portion. Thus, the first lifters 18 in the upper half are closer to the pipe section 2, so that the second lifters 19 in this upper section force the second section 16 of the seal 3 to stretch out wider. In this figure, the seal 3 is not shown seated against the inside surface of the pipe sleeve 31, but rather, that the claws 24 make contact 24 with the inner surface of the sleeve 31. One can see that the knee lifters 17 in the lower portion of the drawing are tilted to a much lesser degree in the tensioned position, with the result that the seal 3 in this lower portion is stretched to a much lesser degree.

Referring still to FIG. 7, with its eccentric arrangement, the sequence for assembling the pipe sleeve adapter 1 on the pipe section 2 within the pipe sleeve 31 is as follows: first, tension is applied to all stretch elements, in this case, then, to all knee lifters 17. This is done by actuating the tensioning clamp 21 that acts on the first lifters 18 of all knee lifters 17, so that the seal 3 is evenly pressed from the inside against the sleeve 31 along its entire circumference. Then, the fixing wedges 25 are driven under the first lifters 18. The fixing wedges 25 differ in height. The figure illustrates that the height of the fixing wedge 25 on the upper side of the pipe section 2 is smaller than the height of the fixing wedge 25 that is mounted on the lower side of the pipe section 2. In this way, different distances between the pipe section 2 and the first lifters 18 are set. Thus, the pipe section 2 within the knee lifters 17 and the radial seal 3 is shifted from an initially central position downward in the radial direction.

The orientation of the pipe section 2 may also be controlled externally, during the installation process, without one having to see inside of the conduit when assembling the adapter. If the height of the fixing wedge 25 that is used in the lowest area of the sleeve adapter 1, i.e., in the area of the conduit sole 32, corresponds to the height of the uppermost fixing wedge 25 plus the wall thickness of the pipe section 2, the result is a smooth, i.e., unstepped, transition from the sleeve adapter 1 to the adjacent pipe sleeve 31, as shown in FIG. 7.

The number of the fixing wedges 25 used determines the gradations in height between the uppermost and the lowermost fixing wedges 25. Managing the fixing wedges 25 is simplified if the fixing wedges 25 are gathered into a common, ring-shaped component or extend outward as individual latches from a common ring, rather than having to handle a plurality of individual fixing wedges 25. The fixing wedges 25 of such a ring may be produced at the factory with the appropriate graduated heights, for adapting the sleeve adapter 1 to the typical inner diameters of pipe sleeves 31. When the wedges are constructed as a single-component ring, then this ring may have a continuously changing cross-sectional geometry along the circumference of the ring.

Similarly to the fixing wedges 25, the first wedges 4, the second wedges 5, or the knee lifters 17 may be combined to a common manageable component, for example, by producing each of these components as injection-molded plastic parts that are connected to each other by thin sprues. Or they may initially be produced as individual components and subsequently in a pre-assembly step connected or coupled with each other by a flexible tape or band. This pre-assembled assembly, one that contains multiple components in the form of fixing wedges 25, first wedges 4, or knee lifters 17, may then be provided as a long strip or a closed ring, thereby simplifying the process of assembling these components on the pipe section 2.

If the knee lifters 17 are arranged on a ring 20 that is constructed as an eccentric ring, then it is possible to eliminate the fixing wedges 25. Thus, for example, the middle sections of the respective knee lifters 17 that are distributed around the circumference of the pipe section 2 differ in distance from the central axis of the pipe section 2.

It is understood that the embodiments described herein are merely illustrative of the present invention. Variations in the construction of the large container may be contemplated by one skilled in the art without limiting the intended scope of the invention herein disclosed and as defined by the following claims.

1. A sleeve adapter for connecting a pipe to a pipe sleeve,
the pipe having an outer diameter that is smaller than an inner diameter of the pipe sleeve, the sleeve adapter comprising:
a cylindrical pipe section;
a seal made of elastically deformable material, the seal encircling the outer circumference of the pipe section and having a first outer diameter that is smaller than the inner diameter of the pipe sleeve when in a relaxed state and, when in a stretched state, a second outer diameter that forms a seal against the inner diameter of the pipe sleeve; and
at least one stretch device that is placed between the cylindrical pipe section and the seal, the stretch device being adjustable to obtain a desired degree of radially outward stretch of the seal to achieve the second outer diameter;
wherein the seal has a first seal section that is tightly connected to the pipe section and a second seal section that is radially outwardly movable; and
wherein the at least one stretch device is movable in its position on the pipe section so as to apply tension to the second section of the seal, thereby obtaining the degree of radially outward stretch of the seal that determines the second outer diameter.

2. The sleeve adapter of claim 1, wherein the stretch device comprises a first wedge and a second wedge that are movable relative each other so as to overlap each other to some degree and wherein the degree of the radially outward stretch of the seal is a function of the degree of overlap of the first wedge and the second wedge.

3. The sleeve adapter of claim 2, wherein a drive ring is movable on the pipe section in the axial direction, so as to move an element of the stretch device in the axial direction.

4. The sleeve adapter of claim 3, wherein the drive ring is a contact ring with a contact surface.

5. The sleeve adapter of claim 4, wherein a clamp ring is fixable in stationary location on the pipe section and has at least one pressure element that extends toward the drive ring, such that, actuation of the pressure element increases a distance between the clamp ring and the drive ring in the axial direction of the pipe section.

6. The sleeve adapter of claim 2, wherein mating surfaces of the first wedge and the second wedge have contours that are constructed to enable a forward movement that increases the degree of overlap of the two wedges and prevents a backward movement that decreases the degree of overlap.

7. The sleeve adapter of claim 2, wherein a plurality of markings are provided in the axial direction on an outer surface of the pipe section.

8. The sleeve adapter of claim 7, wherein each of the markings extends circumferentially around the pipe section.

9. The sleeve adapter of claim 8, wherein the markings are constructed as unbroken lines.

10. The sleeve adapter of claim 7, wherein the markings are visually different.

11. The sleeve adapter of claim 1, wherein the stretch device is a knee lifter having a first lifter and a second lifter and a middle section therebetween that is tiltably mounted on the pipe section;
wherein the first lifter is movable from a resting position in which a free end of the first lifter extends radially outward from the pipe section a first distance and a tensioning position in which the free end extends radially outward a second distance that is smaller than the first distance; and
wherein the second lifter has a free end that makes contact with an inner surface of the second section of the seal and is movable from a resting position in which the free end is closer to the pipe section and a tensioning position in which the free end is farther away from the pipe section, thereby forcing the second section of the seal to stretch to obtain the degree of radially outward stretch of the seal.

12. The sleeve adapter of claim 11, wherein the first section of the seal is an insertion end of the seal, for inserting into the pipe sleeve;
wherein the second lifter extends toward the insertion end of the seal; and
wherein the seal has a U-shaped cross-section at the insertion end, an upper leg of the U connecting with the second section of the seal and a lower leg of the U making contact with the pipe section and extending toward the middle section of the knee lifter.

13. The sleeve adapter of claim 11, wherein a ring is provided on the pipe section that serves to fix the knee lifter in a stationary position on the pipe section, and wherein the middle section of the knee lifter at least partially encircles the ring.

14. The sleeve adapter of claim 13, wherein a plurality of knee lifters are distributed around the pipe section and wherein the ring is an eccentric ring that positions the respective middle sections of the knee lifters different distances from a central axis of the pipe section.

15. The sleeve adapter of claim 11, wherein the second lifter is in movable contact with a pressure plate that presses against an inner surface of the second section of the seal.

16. The sleeve adapter of claim 11, wherein the stretch device includes a plurality of knee lifters;
wherein the first lifter of each knee lifter has a guide surface for receiving a tensioning element that extends circumferentially around the pipe section; and
wherein the tensioning device is in contact with the guide surface of the first lifters of the plurality of knee lifters.

17. The sleeve adapter of claim 11, further comprising a polygonal bearing ring that encircles the pipe section and wherein the middle section of the knee lifter is tiltably mounted on a straight-line section of the polygonal bearing ring.

18. The sleeve adapter of claim 1, wherein the seal has a plurality of circumferentially outer protrusions.

19. The sleeve adapter of claim 1, wherein the stretch device is an element that has a radial inner surface and that is movable in an axial direction along the pipe section; and
wherein a grip claw is provided on the radial inner surface, the grip claw having a contact angle with the pipe section that enables movement of the movable element in a direction that stretches the seal and prevents movement in a direction that decreases stretch on the seal.

20. The sleeve adapter of claim 19, wherein the grip claw is a flat stamped metal component that is oriented at an angled to the surface of the pipe section.

21. The sleeve adapter of claim 20, wherein the grip claw is a metal ring that includes a plurality of grip claws.

22. The sleeve adapter of claim 1, wherein the seal has an expansion joint between the first section and the second section of the seal that enhances an ability of the second section of the seal to stretch radially outward from the pipe section.
